(19) United States
(12) Patent Application Publication
(10) Pub. No.: US 2005/0212980 A1
(43) Pub. Date: Sep. 29, 2005

(54) Display and display method

(75) Inventor: Keiichi Miyazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/070,262

(22) Filed: Mar. 3, 2005

(30) Foreign Application Priority Data
Mar. 23, 2004 (JP) P.2004-084164

(51) Int. Cl. H04N 5/64

(52) U.S. Cl. 348/744

(57) ABSTRACT

A display for converting light emitted from a light source into light of a different wavelength through color filters and projecting the provided light, the display comprising: a pair of color wheels each having a disk shape, wherein each of the pair of color wheels comprises: a first color filter that converts incident light into light having a wavelength of cyan (C); a second color filter that converts incident light into light having a wavelength of magenta (M); and a third color filter that converts incident light into light having a wavelength of yellow (Y), the first, second and third color filters being arranged in a circumferential direction of the color wheel, and wherein the pair of color wheels is placed on the same axis and rotates in synchronization with each other in the circumferential direction.

### BACKGROUND OF THE INVENTION

1. Field of the Invention

This invention relates to a display and a display method for applying light from a light source, converting the light into light of a specific wavelength through color filters, and projecting the provided light onto a screen.

2. Description of the Related Art

At present, for example, a projector of DLP (Digital Light Processing: Registered trademark of Texas Instruments) is available as a display. FIG. 8 is a schematic drawing to describe the DLP projector. As shown in FIG. 8, the DLP uses DMD (Digital Micromirror Device: Registered trademark of Texas Instruments) of an array of 480,000 to 1,310,000 micromirrors 111 on a CMOS semiconductor 110. Light from a light source 101 is converted into RGB in order by a color wheel 120 having an array of RGB color filters and the provided light is applied to the micromirrors 111. A projector 100 projects the light reflected by the micromirrors 111 onto a screen 103 through a projector lens 102.

When an image is projected in the projector, first, preprocessing of converting an image of DVD, digital video, BS digital direction, etc., into a digital signal by a decoder circuit, a memory chip, a video processor, and a digital signal processor for converting from analog form into digital form is performed. The micromirrors 111 of the DMD are switched separately according to the digital signal. Specifically, each of the micromirrors 111 is provided so that it can be inclined −12 degrees (off state) or +12 degrees (on state), and can be switched between on and off at high speed such as several thousand times per second under digital control. For example, light reflected on the micromirror 111 in the off state is absorbed on a light absorption plate and thus is not introduced into the projector lens 102 and thus is not projected onto the screen 103. On the other hand, light reflected on the micromirror 111 in the on state is applied through the projector lens 102 onto the screen 103.

In the projector 100, one micromirror 111 corresponds to one pixel of an image projected onto the screen 103 and the on-off ratio of all micromirrors 111 is controlled so as to correspond to the colors of RGB of light applied through the color wheel 120, whereby the color density of the image displayed on the screen 103 can be adjusted.

The color wheel 120 has a disk shape and includes color filters arranged side by side in the circumferential direction so as to convert light having one wave length of R (red), G (green), and B (blue) of light incident from the light source 101 as the color wheel 120 rotates at high speed in the circumferential direction. The color wheel 120 rotates at given speed in the circumferential direction, converts light from the light source 101 into light of the wavelength of RGB in order through the color filters, and emits the provided light to the DMD. (For example, refer to JP-A-2003-307705.)

FIGS. 9 and 10 are plan views to show color wheels in related arts.

As shown in FIG. 9, a color wheel 200 in a related art includes color filters for separately emitting light of R (red), G (green), and B (blue) wavelengths and a W (white) filter for emitting white light without cutting off light from a light source. The color wheel 200 has a structure of a disk-like arrangement of the R, G, B, and W filters.

As shown in FIG. 10, a color wheel 300 in a related art has a structure of a disk-like arrangement of two or more sets of R, G, and B color filters.

An image projected by a projector having the color wheel 200 in the related art shown in FIG. 9 can be improved with respect to the white intensity because the W filter for emitting white light is included, but black floats and the color reproducibility (contrast) is degraded. An image projected by a projector having the color wheel 300 shown in FIG. 10 is excellent in the color reproducibility, but the white intensity is degraded. That is, to use either the color wheel 200 or 300 with a projector, a tradeoff between the intensity and the color reproducibility of the projected image inevitably occurs.

Usually, the optimum color intensity and color reproducibility vary depending on the use environment of the projector and the contents of the image. Thus, with the projector including the color filter 200 or 300, the intensity and the color reproducibility cannot be set to the suited state in response to the environment and the projected image.

### SUMMARY OF THE INVENTION

It is therefore an object of the invention to provide a display and a display method for making it possible to adjust the intensity and the color reproducibility of an image in response to the use environment and the image.

To accomplish the object of the invention, according to the invention, there can be provided a display for converting light emitted from a light source into light of a different wavelength through color filters and projecting the provided light, the display comprising: a pair of color wheels each having a disk shape, wherein each of the pair of color wheels comprises: a first color filter that converts incident light into light having a wavelength of cyan (C); a second color filter that converts incident light into light having a wavelength of magenta (M); and a third color filter that converts incident light into light having a wavelength of yellow (Y), the first, second and third color filters being arranged in a circumferential direction of the color wheel, and wherein the pair of color wheels is placed on the same axis and rotates in synchronization with each other in the circumferential direction.

The display of the invention converts the light of the light source into color of a combination of CMY by the pair of color wheels each having the CMY color filters and projects the provided light.

C, M, and Y correspond to three primary colors of subtractive color mixture and mean cyan (C), magenta (M), and yellow (Y) respectively. Since the pair of color wheels is arranged side by side so that the rotation axes become the same axes, the light incident on the pair of color wheels is converted into light of a predetermined wavelength by color mixture of CMY.

For example, the light from the light source is converted into light of a wavelength of C through the C color filter of one color wheel and the light of the C wavelength passes through the M color filter of the other color wheel, whereby the light can be converted into light having a wavelength of B (blue) by color mixture of C and M. After the light from the light source is converted into the light of the C wavelength through the C color filter of one color wheel, the light of the C wavelength passes through the C color filter of the other color wheel, whereby the light having the C wavelength can be emitted.

Thus, if the pair of color wheels each having the CMY color filters is used and the positions of the color wheels in the rotation direction thereof are adjusted, substantially light having RGB wavelength or light having CMY wavelength can be projected by color mixture of CMY. At this time, when RGB light is emitted, high color reproducibility can be provided although white intensity is hard to provide; when CMY light is emitted, the white intensity can be enhanced although the color reproducibility is degraded. Further, the relative positions of the pair of color wheels in the rotation direction are changed, so that both CMY light and RGB light can also be emitted.

Therefore, the display according to the invention makes it possible to appropriately set the balance between the intensity and the color reproducibility as required.

Preferably, the display further comprises a color wheel drive section that rotates the pair of color wheels; a control section that controls the color wheel drive section so as to drive the color wheel drive section; and a position sensor that detects positions of the pair of color wheels relative to the rotation direction of the pair of color wheels and outputs a signal indicating the positions to the control section.

In doing so, the position sensor detects the positions of the color wheels and the control section can control the color wheel drive section based on the positions and the objective relative positions of the pair of color wheels with respect to the rotation direction for changing the relative positions of the pair of color wheels. Thus, the overlap area of the CMY color filters in the pair of color wheels in the light passage direction can be adjusted and the ratio between CMY and RGB of the emitted light can be changed.

Therefore, the white intensity and the color reproducibility can be adjusted so as to fit the use environment of the display and the projected image.

To accomplish the above-mentioned object of the invention, according to the invention, there can be provided a display method for converting light emitted from a light source into light of a different wavelength through color filters and projecting the provided light, the display method including the steps of rotating a pair of color wheels each having a disk shape and each having a first color filter for converting incident light into light having a wavelength of cyan (C), a second color filter for converting incident light into light having a wavelength of magenta (M), and a third color filter for converting incident light into light having a wavelength of yellow (Y), the color filters being arranged in a circumferential direction, in synchronization with each other in the circumferential direction on the same axis, applying the light from the light source to the pair of color wheels, converting the light into light having a wavelength of a CMY color mixture, and projecting the provided light.

In the display method of the invention, the pair of color wheels each having the CMY color filters is used and the positions of the color wheels in the rotation direction thereof are adjusted for mixing the CMY colors, whereby light having RGB wavelength is emitted, so that high color reproducibility can be provided; light having CMY wavelength is emitted, so that the white intensity can be enhanced. Further, according to the display method of the invention, the relative positions of the pair of color wheels in the rotation direction are changed, so that both CMY light and RGB light can be emitted.

Therefore, the display method of the invention makes it possible to appropriately set the balance between the intensity and the color reproducibility as required.

### BRIEF DESCRIPTION OF THE DRAWINGS

FIG. 1 is a drawing to describe a display and a display method according to the invention;

FIG. 2A is a plan view to show one color wheel in the display;

FIG. 2B is a plan view to show the other color wheel in the display;

FIG. 3A is a drawing to show the phase in the rotation direction of color filters of one color wheel;

FIG. 3B is a drawing to show the phase in the rotation direction of color filters of the other color wheel;

FIG. 3C is a drawing to show a state in which light of a light source is converted in response to the phases of the color filters of the pair of color wheels shown in FIGS. 3A and 3B;

FIG. 4A is a plan view to show the state of one color wheel when a display mode in which the highest intensity can be provided is set;

FIG. 4B is a plan view to show the state of the other color wheel when the display mode in which the highest intensity can be provided is set;

FIG. 5A is a drawing to show the phase in the rotation direction of the color filters of one color wheel;

FIG. 5B is a drawing to show the phase in the rotation direction of the color filters of the other color wheel;

FIG. 5C is a drawing to show a state in which light of a light source is converted in response to the phases of the color filters of the pair of color wheels shown in FIGS. 5A and 5B;

FIG. 6A is a plan view to show the state of one color wheel when a display mode in which the balance between the intensity and the color reproducibility is adjusted is set;

FIG. 6B is a plan view to show the state of the other color wheel when set to the position for adjusting the balance between the intensity and the color reproducibility;

FIG. 7A is a drawing to show the phase in the rotation direction of the color filters of one color wheel;

FIG. 7B is a drawing to show the phase in the rotation direction of the color filters of the other color wheel;

FIG. 7C is a drawing to show a state in which light of a light source is converted in response to the phases of the color filters of the pair of color wheels shown in FIGS. 7A and 7B;

FIG. 8 is a schematic drawing to describe a DLP projector;

FIG. 9 is a plan view to show a color wheel in a related art; and

FIG. 10 is a plan view to show a color wheel in a related art.

### DETAILED DESCRIPTION OF THE INVENTION

A preferred embodiment of a display and a display method according to the invention will be discussed in detail with reference to the accompanying drawings.

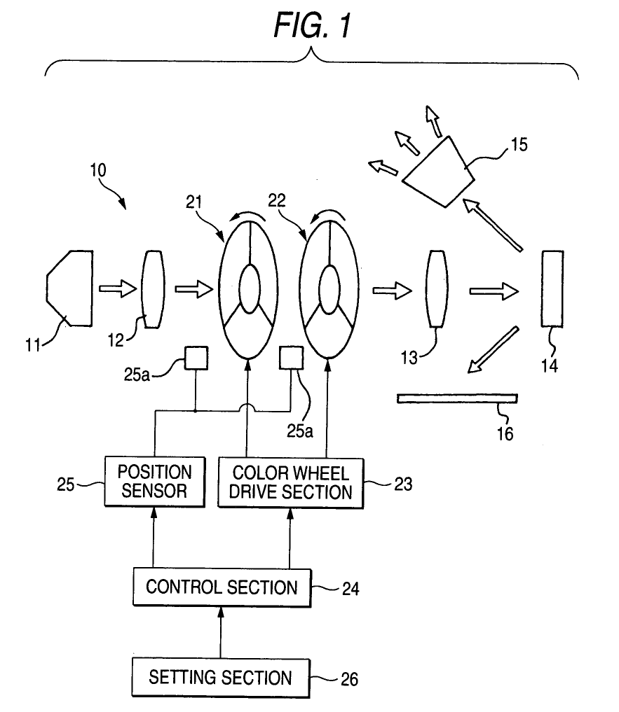

FIG. 1 is a drawing to describe a display according to the invention.

In the embodiment, a DLP projector is used as the display, but the display is not limited to the projector and can be used as any other type of display.

As shown in FIG. 1, a display 10 includes a light source 11 such as a discharge lamp, a condenser lens 12 for gathering light emitted from the light source 11, a pair of color wheels 21 and 22 placed so as to apply light emitted from the condenser lens 12 to a predetermined position, a relay lens 13 for relaying light emitted from the pair of color wheels 21 and 22, a DMD 14, a projector lens 15 for projecting light reflected by micromirrors in the on state in the DMD 14 onto an external screen, and a light absorption plate 16 for absorbing light reflected by micromirrors in the off state in the DMD 14.

In the projector of the embodiment, the light emitted from the light source 11 is gathered on the condenser lens 12 and is guided through the condenser lens 12 so as to be applied to predetermined parts of the color wheels 21 and 22. The light applied to the color wheels 21 and 22 is converted into light having a specific color wavelength through color filters provided for the pair of color wheels 21 and 22. The light emitted from the pair of color wheels 21 and 22 is applied through the relay lens 13 to the DMD 14 and is reflected by the micromirrors whose on state and off state are controlled in response to digital image data. The light reflected by the micromirrors in the on state is enlarged through the projector lens 15 and is projected onto a screen (not shown). An image is thus displayed on the screen. The digital image data is provided by converting an input image signal into a digital signal having as many pixels as the number of the micromirrors as preprocessing.

The display 10 of the embodiment includes a control system made up of a color wheel drive section 23 for rotating the pair of color wheels 21 and 22 in synchronization with each other and a control section 24 for outputting a drive signal to the color wheel drive section 23. A position sensor 25 for detecting the positions of the pair of color wheels 21 and 22 in the rotation direction thereof by detection elements 25a is provided so as to electrically connect to the control section 24.

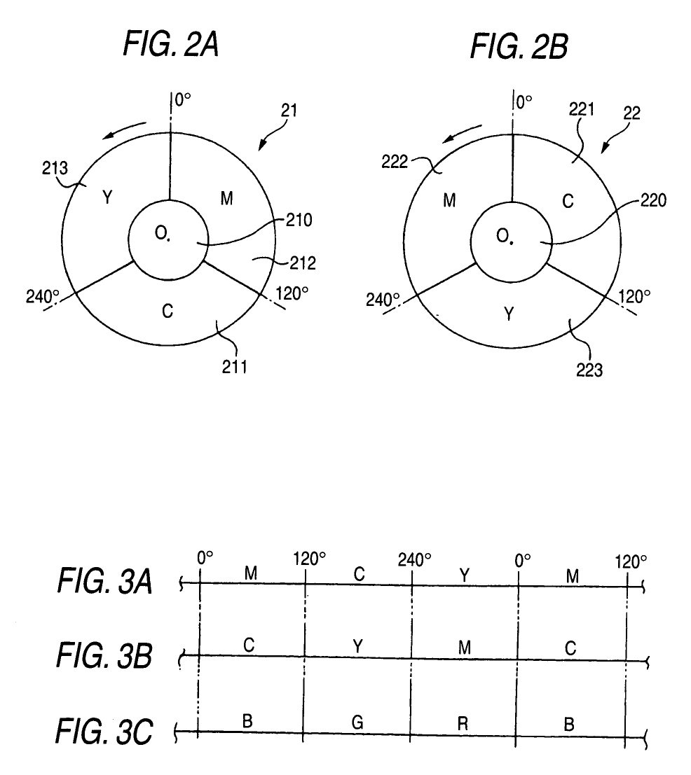

FIG. 2A is a plan view to show one color wheel in the display of the embodiment. FIG. 2B is a plan view to show the other color wheel in the display of the embodiment. The pair of color wheels 21 and 22 has the same disk shape and is provided with support sections 210 and 220 at the center on the plan view. Each of the color wheels 21 and 22 can rotate in the direction indicated by the arrow in the figure with a shaft O positioned at the center of the support section 210, 220 as the center. In the embodiment, one color wheel 21 is placed on the side of the light source 11 and the other color wheel 22 is placed on the side of the DMD 14. The pair of color wheels 21 and 22 is driven by the color wheel drive section 23 shown in FIG. 1 so that the color wheels 21 and 22 are synchronized with each other.

As shown in FIGS. 2A, 2B, in the color wheel 21, 22, color filters formed roughly like three sectors equal in size are placed surrounding the support section 210, 220. One color wheel 21 is made up of a first color filter 211 for converting incident light into light having the C (cyan) wavelength, a second color filter 212 for converting incident light into light having the M (magenta) wavelength, and a third color filter 213 for converting incident light into light having the Y (yellow) wavelength.

The first to third color filters 211, 212, and 213 are provided so as to become the same shape and the same size.

Likewise, the other color wheel 22 is made up of a first color filter 221 for converting incident light into light having the C wavelength, a second color filter 222 for converting incident light into light having the M wavelength, and a third color filter 223 for converting incident light into light having the Y wavelength.

The first to third color filters 221, 222, and 223 are provided so as to become the same shape and the same size and so that the color filters and the color filters 211, 212, and 213 of one color wheel 21 become equal in CMY placement order with respect to the rotation direction.

The light incident on the pair of color wheels 21 and 22 is converted into light of any wavelength of CMY through the C, M, or Y color filter of one color wheel 21 and then the light provided by one color wheel 21 is further converted into light of a specific wavelength through the C, M, or Y color filter of the other color wheel 22. For example, if light is converted into light of the M wavelength through the M color filter 212 of one color wheel 21 and the light of the M wavelength is applied to the C color filter 221 of the other color wheel 22, light of the B (blue) wavelength as a color mixture of M and C is provided.

That is, the display of the embodiment converts light from the light source into light of the wavelength of the color generated by color mixing of CMY by the pair of color wheels 21 and 22 each having the CMY color filters.

Before an image is projected, the display 10 according to the invention can be set to any of a display mode in which the relative positions of the pair of color wheels 21 and 22 in the rotation direction thereof can be changed and the highest color reproducibility can be provided, a display mode in which the highest intensity can be provided, or a display mode in which the balance between the intensity and the color reproducibility is adjusted. The configuration and function of the pair of color wheels 21 and 22 in each of the display modes will be discussed below:

FIGS. 2A and 2B are plan views to show the state of each color wheel when the display mode in which the highest color reproducibility can be provided is set. In FIGS. 2A and 2B, to describe the positions of the color filters, the perimeter of each color wheel is 360 degrees and the positions of 120 degrees and 240 degrees are shown clockwise with the position of 12 o'clock as 0 degrees. FIG. 3A shows the phase in the rotation direction of the color filters of one color wheel, FIG. 3B shows the phase in the rotation direction of the color filters of the other color wheel, and FIG. 3C shows a state in which light of the light source is converted in response to the phases of the color filters of the pair of color wheels shown in FIGS. 3A and 3B.

One color wheel 21 shown in FIG. 2A has the M color filter 212 placed in the area of 0 degrees to 120 degrees, the C color filter 211 placed in the area of 120 degrees to 240 degrees, and the Y color filter 213 placed in the area of 240 degrees to 0 (360) degrees. In contrast, the other color wheel 22 has the C color filter 221 placed in the area of 0 degrees to 120 degrees, the Y color filter 223 placed in the area of 120 degrees to 240 degrees, and the M color filter 222 placed in the area of 240 degrees to 0 degrees.

To begin with, when one color wheel 21 is rotated in the arrow direction in the figure in a state in which light from the light source is applied to the area of 0 degrees to 120 degrees in the color wheel 21, the light application position from the light source moves to the areas of the color filters in the order of M, C, Y, M . . . Thus, the light incident on the color wheel 21 is also converted into light of the wavelength of each color in the order of M, C, Y, M . . .

The light emitted from one color wheel 21 is applied to the color filters of the other color wheel 22 in order. At this time, the light application position from one color wheel 21 to the other color wheel 22 moves to the areas of the color filters in the order of C, Y, M, C . . . as shown in FIG. 2B.

Thus, when M light is emitted from the M color filter of one color wheel 21, the light from the light source is converted into B of color mixture of M and C through the C color filter in the same phase in the rotation direction in the other color wheel 22. When C light is emitted from the C color filter of one color wheel 21, the light is converted into G (green) of color mixture of C and Y through the Y color filter in the same phase in the rotation direction in the other color wheel 22. Further, when Y light is emitted from the Y color filter of one color wheel 21, the light is converted into R (red) of color mixture of Y and M through the M color filter in the same phase in the rotation direction in the other color wheel 22.

In other words, the CMY color filters are placed so that R, G, or B results from mixing the colors in the same phase in the pair of color wheels 21 and 22 as shown in FIGS. 2A and 2B. Thus, the display 10 converts the light from the light source 11 into light in the order of B, G, R, B . . .

In doing so, the display 10 converts the light from the light source 11 into light of the wavelength of any of R, G, or B and then projects the light through the DMD 14 from the projector lens 15. Thus, the projected image is provided by light having the R, G, and B wavelengths and the highest color reproducibility is provided.

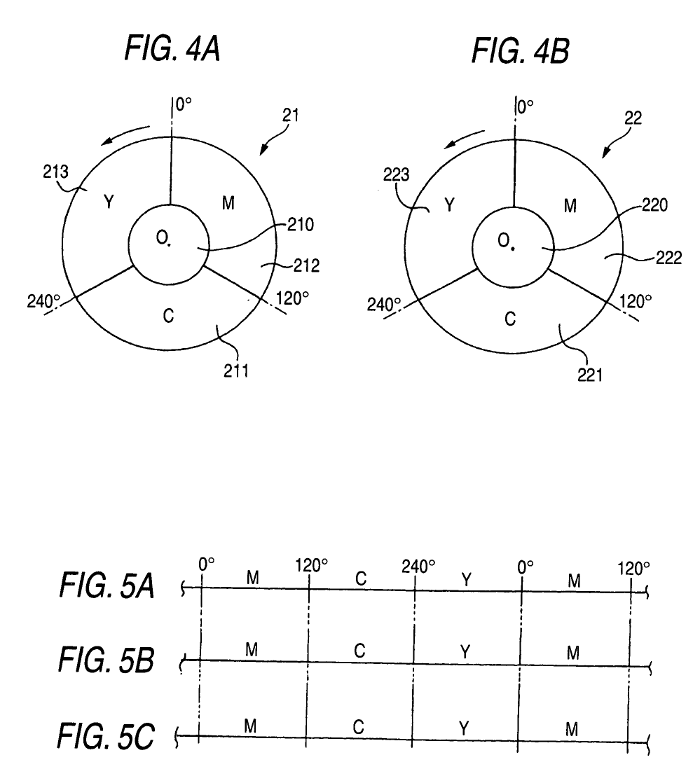

FIGS. 4A and 4B are plan views to show the state of each color wheel when the display mode in which the highest intensity can be provided is set. FIG. 5A shows the phase in the rotation direction of the color filters of one color wheel, FIG. 5B shows the phase in the rotation direction of the color filters of the other color wheel, and FIG. 5C shows a state in which light of the light source is converted in response to the phases of the color filters of the pair of color wheels shown in FIGS. 5A and 5B.

One color wheel 21 shown in FIG. 4A has the M color filter 212 placed in the area of 0 degrees to 120 degrees, the C color filter 211 placed in the area of 120 degrees to 240 degrees, and the Y color filter 213 placed in the area of 240 degrees to 0 (360) degrees. In contrast, the other color wheel 22 has the M color filter 222 placed in the area of 0 degrees to 120 degrees, the C color filter 221 placed in the area of 120 degrees to 240 degrees, and the Y color filter 223 placed in the area of 240 degrees to 0 degrees.

To begin with, light applied from the light source 11 to one color wheel 21 is converted into light of the wavelength of each color in the order of M, C, Y, M . . . When the light emitted from one color wheel 21 is applied to the color filters of the other color wheel 22 in order at the same time, the light application position from one color wheel 21 to the other color wheel 22 moves to the areas of the color filters in the order of M, C, Y, and M . . . as shown in FIG. 4B.

Thus, when the light from the light source is applied to one color wheel 21, if M light is emitted from the M color filter 212, the light is applied to the M color filter 222 in the same phase in the other color wheel 22. If C light is emitted from the C color filter 211, the light is applied to the C color filter 221 in the same phase in the other color wheel 22. If Y light is emitted from the Y color filter 213, the light is applied to the Y color filter 223 in the same phase in the other color wheel 22.

In the light emitted from one color wheel 21, the light having the M wavelength is applied to the same M color filter 222 in the other color wheel 22 and thus is not converted into light of any other wavelength and light of the same M wavelength is emitted from the other color wheel 22. Likewise, the light having the C wavelength is applied to the same C color filter 221 in the other color wheel 22 and thus light of the same C wavelength is emitted from the other color wheel 22. The light having the Y wavelength is applied to the same Y color filter 223 in the other color wheel 22 and thus light of the same Y wavelength is emitted from the other color wheel 22.

In other words, the CMY color filters are set to the same CMY positions with respect to the same phase in the pair of color wheels 21 and 22 as shown in FIGS. 4A and 4B. Thus, the display 10 converts the light from the light source 11 into light in the order of M, C, Y, M . . . and applies the provided light to the DMD 14.

In doing so, the display 10 converts the light from the light source 11 into light of the wavelength of any of C, M, or Y and thus can provide the highest intensity of the projected image.

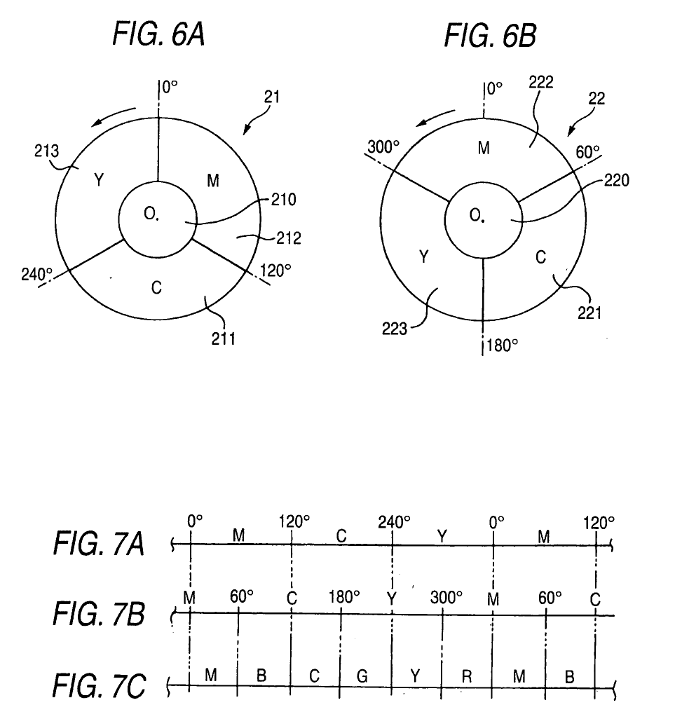

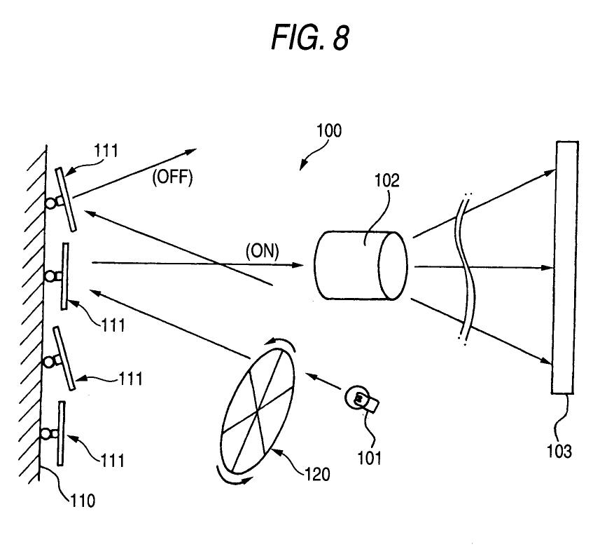

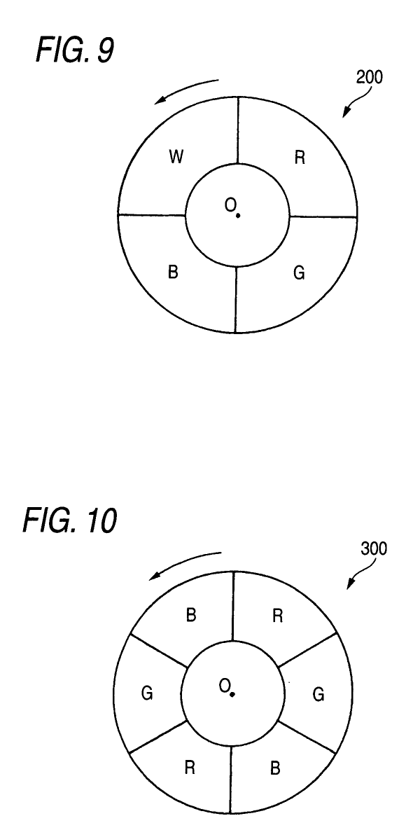

Next, an example of the display mode in which the balance between the intensity and the color reproducibility is adjusted in response to the purpose will be discussed with reference to FIGS. 6 and 7.

FIGS. 6A and 6B are plan views to show the state of each color wheel when set to the position for adjusting the balance between the intensity and the color reproducibility. FIG. 7A shows the phase in the rotation direction of the color filters of one color wheel, FIG. 7B shows the phase in the rotation direction of the color filters of the other color wheel, and FIG. 7C shows a state in which light of the light source is converted in response to the phases of the color filters of the pair of color wheels shown in FIGS. 7A and 7B.

One color wheel 21 shown in FIG. 6A has the M color filter 212 placed in the area of 0 degrees to 120 degrees, the C color filter 211 placed in the area of 120 degrees to 240 degrees, and the Y color filter 213 placed in the area of 240 degrees to 0 (360) degrees. In contrast, the other color wheel 22 has the C color filter 221 placed in the area of 60 degrees to 180 degrees, the Y color filter 223 placed in the area of 180 degrees to 300 degrees, and the M color filter 222 placed in the area of 300 (−60) degrees to 60 degrees containing the position of 0 degrees.

To begin with, light applied from the light source 11 to one color wheel 21 is converted into light of the wavelength of each color in the order of M, C, Y, M . . . When the light emitted from one color wheel 21 is applied to the color filters of the other color wheel 22 in order at the same time, the light application position from one color wheel 21 to the other color wheel 22 moves to the areas of the color filters in the order of M, C, Y, and M . . . as shown in FIG. 6B.

At this time, the color filters 221, 222, and 223 in the other color wheel 22 are set to the positions where the phase in the rotation direction leads 60 degrees with respect to the color filters 211, 212, and 213 in one color wheel 21.

Thus, when the M light is emitted from one color wheel 21, in the other color wheel 22, the light is applied to the M color filter 222 between 0 and 60 degrees and is applied to the C color filter 221 between 60 and 120 degrees. When the C light is emitted from one color wheel 21, in the other color wheel 22, the light is applied to the C color filter 221 between 120 and 180 degrees and is applied to the Y color filter 223 between 180 and 240 degrees. Further, when the Y light is emitted from one color wheel 21, in the other color wheel 22, the light is applied to the Y color filter 223 between 240 and 300 degrees and is applied to the M color filter 222 between 300 and 360 degrees.

At this time, when the light from the light source is incident between 0 and 60 degrees, between 120 and 180 degrees, and between 240 and 300 degrees relative to the phases of the pair of color wheels 21 and 22, the light having the wavelength of any of M, C, or Y emitted from one color wheel 21 is not converted in the other color wheel 22 and the light having the same M, C, Y wavelength is emitted. On the other hand, when the light from the light source is incident between 60 and 120 degrees, between 180 and 240 degrees, and between 300 and 360 (0) degrees relative to the phases of the pair of color wheels 21 and 22, the M light is converted through the C color filter 221 or the C light is converted through the Y color filter 223 or the Y light is converted through the M color filter 222.

In other words, as shown in FIGS. 6A and 6B, the CMY color filters in the pair of color wheels 21 and 22 are placed so as to have a predetermined phase difference (in the example, 60 degrees). Thus, the display 10 can convert the light from the light source 11 in the order of M, B, C, G, Y, R, M . . . and can apply the provided light to the DMD 14.

In the example, the phase difference between the CMY color filters of the pair of color wheels 21 and 22 relative to the rotation direction thereof is set to 60 degrees, but can be set in the range of 0 to less than 120 degrees.

Specifically, to enhance the intensity of the projected image, the phase difference is lessened for increasing the range in which the color filters of the same color of CMY overlap with respect to the phase in the rotation direction. Then, referring to FIG. 7C, the time required for converting the light from the light source into light having the CMY wavelength by the pair of color wheels 21 and 22 can be prolonged and the intensity of the light emitted in one cycle of the color wheel is increased. Thus, it is made possible to improve the intensity of the image projected onto the screen.

To enhance the color reproducibility of the projected image, the phase difference is increased for increasing the range in which the M color filter 212 and the C color filter 221 overlap, the range in which the C color filter 211 and the Y color filter 223 overlap, and the range in which the Y color filter 213 and the M color filter 222 overlap in the phase in the rotation direction of the pair of color wheels 21 and 22.

Then, referring to FIG. 7C, the time required for converting the light from the light source into light having the RGB wavelength by the pair of color wheels 21 and 22 can be prolonged and it is made possible to the color reproducibility of the image projected onto the screen.

Thus, the display 10 can adjust the balance between the intensity and the color reproducibility appropriately in response to the objective image.

The phase difference between the color filters of the pair of color wheels 21 and 22 can be set as either or both of the pair of color wheels 21 and 22 are moved in the rotation direction.

The process of setting the phase difference between the color filters of the pair of color wheels 21 and 22 will be discussed.

As shown in FIG. 1, the position sensor 25 detects the color filter positions (phases) in the pair of color wheels 21 and 22 by the detection elements 25a and outputs a position signal to the control section 24. The control section 24 outputs a drive signal to drive the pair of color wheels 21 and 22 so as to match with the phase difference to the color wheel drive section 23 as required based on the objective phase difference and the position signal. The color wheel drive section 23 drives either or both of the pair of color wheels 21 and 22 in the rotation direction in response to the drive signal.

The display 10 of the embodiment is provided with a setting section 26 for inputting a setting signal to set the rotation start position of the color wheel to the control section 24.

The user sets the objective intensity or color reproducibility through the setting section 26, whereby the objective phase difference is calculated in response to a previously recorded correction table and a drive signal is transmitted from the control section 24 to the color wheel drive section 23 so as to match with the objective phase difference. The control section 24 may detect the ambient lightness, etc., by a sensor and may control the color wheel drive section 23 so as to adjust the balance between the intensity and the color reproducibility automatically without providing the display 10 with the setting section 26.

Thus, the display 10 according to the invention is a display for converting light emitted from the light source 11 into light of a different wavelength through the color filters and projecting the provided light, the display including the pair of color wheels 21 and 22 each having a disk shape, characterized in that the pair of color wheels 21 and 22 has each the first color filter 211, 221 for converting incident light into light having a wavelength of C, the second color filter 212, 222 for converting incident light into light having a wavelength of M, and the third color filter 213, 223 for converting incident light into light having a wavelength of Y, the color filters being arranged in a circumferential direction of the color wheel, and is placed on the same axis and rotates in synchronization with each other in the circumferential direction.

Since the display 10 uses the pair of color wheels 21 and 22 each having the CMY color filters, if the positions of the color wheels in the rotation direction thereof are adjusted, substantially light having RGB wavelength or light having CMY wavelength can be projected by color mixture of CMY. At this time, when RGB light is emitted, high color reproducibility can be provided although white intensity is hard to provide; when CMY light is emitted, the white intensity can be enhanced although the color reproducibility is degraded. Further, the relative positions of the pair of color wheels in the rotation direction are changed, so that both CMY light and RGB light can also be emitted.

Therefore, the display according to the invention makes it possible to appropriately set the balance between the intensity and the color reproducibility as required.

The display method according to the invention is a display method for converting light emitted from the light source 11 into light of a different wavelength through the color filters and projecting the provided light, the display method including the steps of rotating the pair of color wheels 21 and 22 each having a disk shape and each having the first color filter 211, 221 for converting incident light into light having a wavelength of C, the second color filter 212, 222 for converting incident light into light having a wavelength of M, and the third color filter 213, 223 for converting incident light into light having a wavelength of Y, the color filters being arranged in a circumferential direction, in synchronization with each other in the circumferential direction on the same axis, applying the light from the light source 11 to the pair of color wheels 21 and 22, converting the light into light having a wavelength of a CMY color mixture, and projecting the provided light.

According to the display method, the pair of color wheels 21 and 22 each having the CMY color filters is used and the positions of the color wheels in the rotation direction thereof are adjusted for mixing the CMY colors, whereby light having RGB wavelength is emitted, so that high color reproducibility can be provided; light having CMY wavelength is emitted, so that the white intensity can be enhanced. Further, according to the display method of the invention, the relative positions of the pair of color wheels 21 and 22 in the rotation direction are changed, so that both CMY light and RGB light can be emitted.

Therefore, the display method of the invention makes it possible to appropriately set the balance between the intensity and the color reproducibility as required.

The invention is not limited to the embodiment described above and appropriate modifications, improvement, etc., can be made.

For example, the display according to the invention is not limited to the use as a DLP projector as in the embodiment and can be used as a light source for supplying color light to a projection apparatus for projecting an image onto a screen.

The invention can provide the display and the display method for making it possible to adjust the intensity and the color reproducibility of an image.

The entire disclosure of each and every foreign patent application from which the benefit of foreign priority has been claimed in the present application is incorporated herein by reference, as if fully set forth.

1. A display for converting light emitted from a light source into light of a different wavelength through color filters and projecting the provided light, the display comprising:
a pair of color wheels each having a disk shape,
wherein each of the pair of color wheels comprises: a first color filter that converts incident light into light having a wavelength of cyan (C); a second color filter that converts incident light into light having a wavelength of magenta (M); and a third color filter that converts incident light into light having a wavelength of yellow (Y), the first, second and third color filters being arranged in a circumferential direction of the color wheel, and
wherein the pair of color wheels is placed on the same axis and rotates in synchronization with each other in the circumferential direction.

2. The display as claimed in claim 1 further comprising:
a color wheel drive section that rotates the pair of color wheels;
a control section that controls the color wheel drive section so as to drive the color wheel drive section; and
a position sensor that detects positions of the pair of color wheels relative to the rotation direction of the pair of color wheels and outputs a signal indicating the positions to the control section.

3. A display method for converting light emitted from a light source into light of a different wavelength through color filters and projecting the provided light, the display method comprising:
rotating a pair of color wheels each having a disk shape, in synchronization with each other in the circumferential direction on the same axis, each of the pair of color wheels having a first color filter that converts incident light into light having a wavelength of cyan (C), a second color filter that converts incident light into light having a wavelength of magenta (M), and a third color filter that converts incident light into light having a wavelength of yellow (Y), wherein the first, second and third color filters being arranged in a circumferential direction;
applying the light from the light source to the pair of color wheels;
converting the light into light having a wavelength of a CMY color mixture; and
projecting the provided light.
